(19) United States
(12) Patent Application Publication
(10) Pub. No.: US 2017/0187927 A1
(43) Pub. Date: Jun. 29, 2017

(54) METHOD AND ELECTRONIC DEVICE FOR SWITCHING VIDEO DISPLAY WINDOW

(71) Applicants: LE HOLDINGS (BEIJING) CO., LTD., Beijing (CN); LE SHI INTERNET INFORMATlON & TECHNOLOGY CORP., BEIJING, BEIJING (CN)

(72) Inventor: Xianjin Cao, Beijing (CN)

(21) Appl. No.: 15/243,840

(22) Filed: Aug. 22, 2016

Related U.S. Application Data
(63) Continuation of application No. PCT/CN2016/088997, filed on Jul. 6, 2016.

(30) Foreign Application Priority Data
Dec. 25, 2015 (CN) 201510996490.X

(51) Int. Cl. H04N 3/23; H04N 5/45; H04N 7/01

(52) U.S. Cl. CPC H04N 3/23; H04N 7/0122; H04N 5/45

(57) ABSTRACT

The present application discloses a method and an electronic device for switching video display window. The method for switching the video display window includes: acquiring a width-height ratio of a video displayed in a current video display window and a width-height ratio of a target video display window when it is monitored that there is a video display window switching command; contrasting the width-height ratio of the video with the width-height ratio of the target video display window; and adjusting the width-height ratio of the target video display window to the width-height ratio of the video when the width-height ratio of the video is inconsistent with the width-height ratio of the target video display window.

### CROSS-REFERENCES TO RELATED APPLICATIONS

The present application is a continuation application of a PCT application No. PCT/CN2016/088997, filed on Jul. 6, 2016; and claims the priority from Chinese patent application No. 201510996490.X, titled “Method and Device for Switching Video Display Window”, filed on Dec. 25, 2015 to State Intellectual Property Office, the disclosures of which are hereby incorporated by reference.

### TECHNICAL FIELD

The present application relates to the field of video processing technologies, and for example, relates to a method and an electronic device for switching video display window.

### BACKGROUND

Watching videos on display devices such as computers through Internet becomes more common since videos watched on the Internet can be freely selected without limitation of time and place.

When watching videos, many users like to play videos in a small window; however, videos played in a full screen are often zoomed according to a size of the small window when videos are played in the small window in the related art. While realizing the present application, inventors have discovered that there are at least following problems in the related art. When switching is made between full-screen display and small-window display, display picture distortion of videos may occur due to different length-width ratios since there are many kinds of picture display scales in the related art, e.g., a length-width ratio may be 16:9, 4:3 and the like, thereby affecting normal watching of users.

### SUMMARY

The present application provides a method and an electronic device for switching video display window, so as to solve a problem of video deformation and distortion caused by switching of video display window.

In a first aspect, embodiments of the present application provide a method for switching video display window, including:

acquiring a width-height ratio of a video displayed in a current video display window and a width-height ratio of a target video display window when it is monitored that there is a video display window switching command;

contrasting the width-height ratio of the video with the width-height ratio of the target video display window; and

adjusting the width-height ratio of the target video display window to the width-height ratio of the video when the width-height ratio of the video is inconsistent with the width-height ratio of the target video display window.

In a second aspect, embodiments of the present application further provide an electronic device for switching video display window, including:

at least one processor; and

a memory communicably connected with the at least one processor for storing instructions executable by the at least one processor, wherein execution of the instructions by the at least one processor causes the at least one processor to:

acquire a width-height ratio of a video displayed in a current video display window and a width-height ratio of a target video display window when it is monitored that there is a video display window switching command;

contrast the width-height ratio of the video with the width-height ratio of the target video display window; and

adjust the width-height ratio of the target video display window to the width-height ratio of the video when the width-height ratio of the video is inconsistent with the width-height ratio of the target video display window.

In a third aspect, embodiments of the present application further provide a non-transitory computer-readable storage medium storing computer executable instructions that, when executed by an electronic device, cause the electronic device to:

acquire a width-height ratio of a video displayed in a current video display window and a width-height ratio of a target video display window when it is monitored that there is a video display window switching command;

contrast the width-height ratio of the video with the width-height ratio of the target video display window; and

adjust the width-height ratio of the target video display window to the width-height ratio of the video when the width-height ratio of the video is inconsistent with the width-height ratio of the target video display window.

### DESCRIPTION OF THE DRAWINGS

At least one embodiment is illustrated by way of example, and not by limitation, in the figures of the accompanying drawings, wherein elements having the same reference numeral designations represent like elements throughout. The drawings are not to scale, unless otherwise disclosed.

FIG. 1 is a flow diagram showing a method for switching video display window provided in embodiment 1 of the present application;

FIG. 2 is a flow diagram showing a method for switching video display window provided in embodiment 2 of the present application;

FIG. 3 is a schematic structural diagram showing a device for switching video display window provided in embodiment 3 of the present application; and

FIG. 4 is a functional block diagram showing a hardware structure of a device provided in embodiment 5 of the present application.

### DETAILED DESCRIPTION

The present application will be described in detail below in combination with drawings and embodiments. It should be understood that embodiments described here are only used for explaining the present application, not used for limiting the present application. In addition, it should be noted that for ease of description, drawings only show some structures related to the present application rather than all structures.

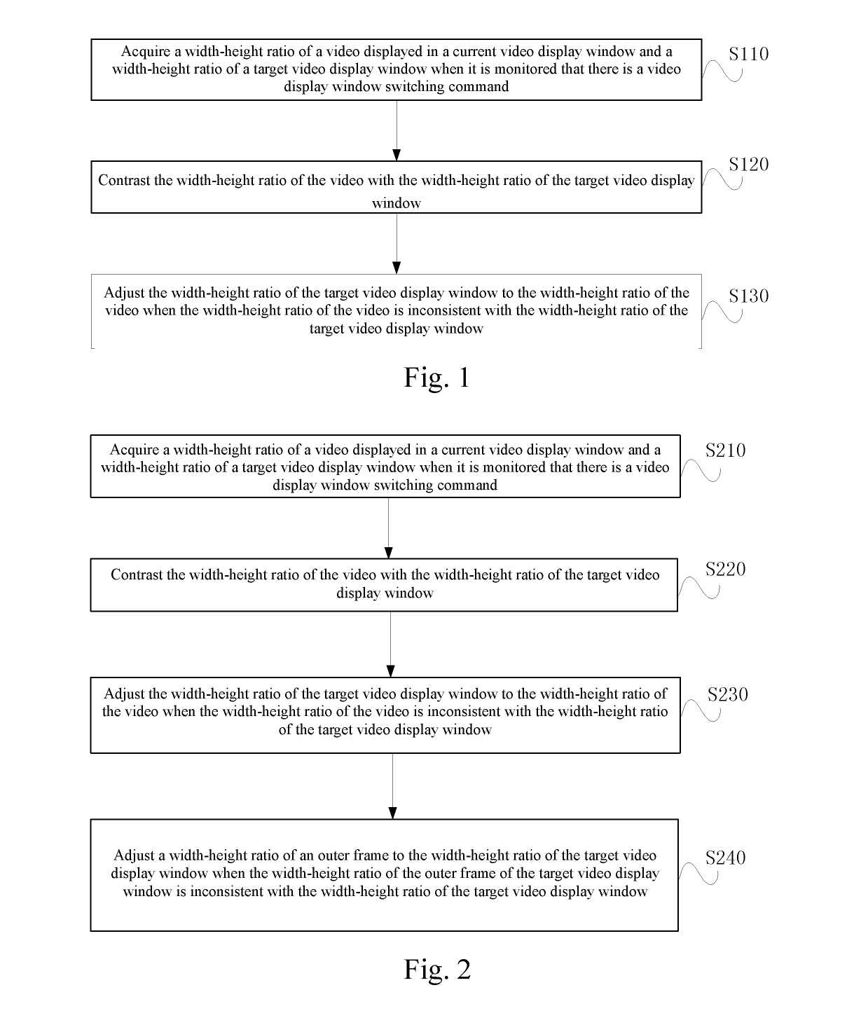

FIG. 1 is a flow diagram showing a method for switching video display window provided in embodiment 1 of the present application. The present embodiment is applicable for a situation for switching a video window, and the method can be executed through a device for switching the video display window. As shown in FIG. 1, the method for switching the video display window provided in embodiment 1 of the present application includes following operations.

In S110, a width-height ratio of a video displayed in a current video display window and a width-height ratio of a target video display window are acquired when it is monitored that there is a video display window switching command.

Alternatively, the video display window switching command may be sent immediately by a user, or may be a timing switching command set in advance. The operation may be used as a basis for a subsequent step of an operation contrasting the width-height ratio of the video with the width-height ratio of the target video display window.

In S120, The width-height ratio of the video is contrasted with the width-height ratio of the target video display window.

The operation may be used as a basis on whether to adjust the width-height ratio of the target video display window. When the width-height ratio of the video is consistent with the width-height ratio of the target video display window, no subsequent operation is performed.

In S130, The width-height ratio of the target video display window is adjusted to the width-height ratio of the video when the width-height ratio of the video is inconsistent with the width-height ratio of the target video display window.

In the present embodiment, the width-height ratio of the video displayed in a current video display window and the width-height ratio of the target video display window are acquired when it is monitored that there is a video display window switching command; the width-height ratio of the video displayed in the current video display window is contrasted with the width-height ratio of the target video display window; the width-height ratio of the target video display window is adjusted to the width-height ratio of the video when the width-height ratio of the video is inconsistent with the width-height ratio of the target video display window, so that a video picture displayed after the current video display window is switched to the target video window would not be distorted due to deformation, thereby ensuring that the user can feel a good visual effect when watching the video.

Alternatively, on the basis of the above embodiment, adjusting the width-height ratio of the target video display window to the width-height ratio of the current video display window includes:

adjusting a width and/or a length of the target video display window so as to adjust the width-height ratio of the target video display window to the width-height ratio of the video. Exemplarily, when the width of the target video display window is adjusted, the length of the target video display window is unchanged; or, when the length of the target video display window is adjusted, the width of the target video display window is unchanged; or when both the height and the width of the target video display window are adjusted at the same time, the height and the width of the target video display window may be adjusted at the same time according to the width-height ratio of the current video display window by keeping a diagonal length of the target video display window unchanged, which is only for illustration here rather than limitation.

Alternatively, on the basis of the above embodiment, acquiring a width-height ratio of a video displayed in a current video display window may include:

acquiring the width-height ratio of the video by decoding the video displayed in the current video display window. An original width and an original height of the video may be obtained by decoding the video displayed in the current video display window, and then the width-height ratio of the video is obtained by computing according to the original height and the original width of the video. Exemplarily, when resolution of the video is 480P (640 pixels×480 pixels), i.e., the original width of the video has 640 pixels and the original height of the video has 480 pixels, then the width-height ratio is 4/3; and when resolution of the video is 720P (1280 pixels×720 pixels), i.e., the original width of the video has 1280 pixels and the original height of the video has 720 pixels, then the width-height ratio is 16/9.

Alternatively, on the basis of the above embodiment, the current video display window and the target video display window may display at the same time. The current video display window may be a full-screen display window and the target video display window may be a small window in non-full-screen display; the small window is located above the full-screen display window and shields part of regions of the full-screen display window; or, the current video display window may be a large window in non-full-screen display, the target video display window may be a small window in non-full-screen display, and the large window and the small window display at the same time without shielding each other. It should be noted that number of the small window is not defined, and there may be at least one small window.

Alternatively, on the basis of the above embodiment, the current video display window may be a full screen display window, and the target video display window may be a preview window in non-full screen display.

The technical solutions in the above embodiment are illustrated below.

Exemplarily, a user can adopt the above method to display when watching a certain video in a full screen by a television;

a width-height ratio of a video displayed in a full screen display window and a width-height ratio of a preview window in non-full screen display to which is to be switched are acquired when it is monitored that there is a video display window switching command;

the width-height ratio of the video is contrasted with the width-height ratio of the preview window; and

the width-height ratio of the preview window is adjusted to the width-height ratio of the video for display when the width-height ratio of the video is inconsistent with the width-height ratio of the preview window.

Benefits of such a setting lie in that: when the user watches the video in switching windows, the width-height ratio of the video displayed in the full screen display window is consistent with the width-height ratio of the preview window, so that a situation of picture deformation and distortion caused by vertical or transverse stretching of a video display picture would not occur, thereby enhancing watching experience of the user.

It should be explained that the above is only for illustrating application conditions of the above embodiment, rather than limitation.

FIG. 2 is a flow diagram showing a method for switching video display window provided in embodiment 2 of the present application. As shown in FIG. 2, the method for switching the video display window provided in embodiment 2 of the present application includes following operations.

In S210, a width-height ratio of a video displayed in a current video display window and a width-height ratio of a target video display window are acquired when it is monitored that there is a video display window switching command.

In S220, The width-height ratio of the video is contrasted with the width-height ratio of the target video display window.

In S230, The width-height ratio of the target video display window is adjusted to the width-height ratio of the video when the width-height ratio of the video is inconsistent with the width-height ratio of the target video display window.

In S240, A width-height ratio of an outer frame is adjusted to the width-height ratio of the target video display window when the width-height ratio of the outer frame of the target video display window is inconsistent with the width-height ratio of the target video display window.

No black region exists between the outer frame and the target video display window through the operation, thereby reducing an area of a display screen occupied by a region surrounded by the outer frame of the target video display window, and enhancing visual experience of the user and a use rate of the display screen.

In the present embodiment, the width-height ratio of the target video display window is adjusted so that the width-height ratio of the target video display window is consistent with the width-height ratio of the video displayed in the current video display window; thus, a visual feel of transverse or vertical stretching on the video due to different width-height ratios of windows before and after switching would not occur when the user switches windows, thereby enhancing visual experience of the user. Moreover, the width-height ratio of the outer frame of the target video display window is adjusted to the width-height ratio of the target video display window when switching windows. Benefits of such a setting lie in that: a watching feel of the user can be prevented from being affected by a black region between the outer frame and the target video display window caused by inconsistent ratios of the outer frame and the target video display window; and problems of waste of a display area of the display screen caused therefrom, influence on display of other contents on the display screen and the like can also be avoided.

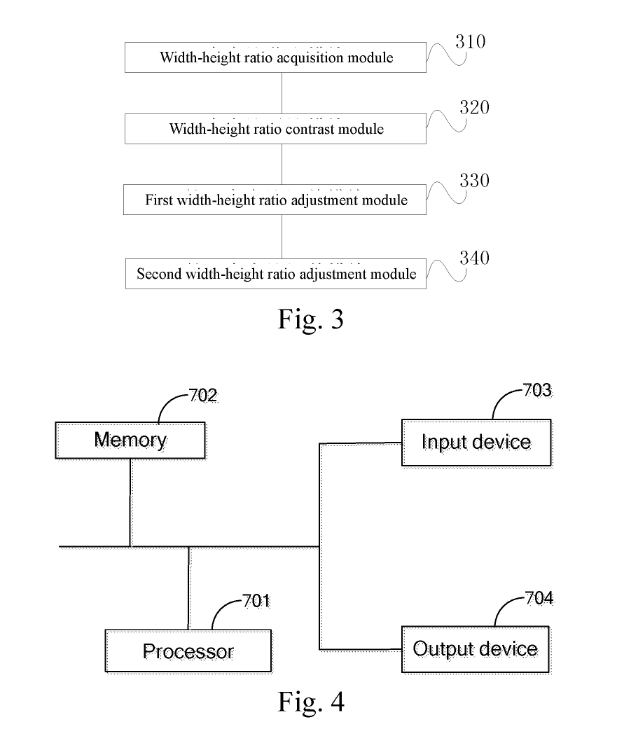

FIG. 3 is a schematic structural diagram showing a device for switching video display window provided in embodiment 3 of the present application. As shown in FIG. 3, the device for switching the video display window provided in embodiment 3 of the present application mainly includes:

a width-height ratio acquisition module 310, a width-height ratio contrast module 320 and a first width-height ratio adjustment module 330;

where the width-height ratio acquisition module 310 is configured to acquire a width-height ratio of a video displayed in a current video display window and a width-height ratio of a target video display window when it is monitored that there is a video display window switching command;

the width-height ratio contrast module 320 is configured to contrast the width-height ratio of the video with the width-height ratio of the target video display window; and

the first width-height ratio adjustment module 330 is configured to adjust the width-height ratio of the target video display window to the width-height ratio of the video when the width-height ratio of the video is inconsistent with the width-height ratio of the target video display window.

In the present embodiment, a width-height ratio of a video displayed in a current video display window and a width-height ratio of a target video display window are acquired when it is monitored that there is a video display window switching command by the width-height ratio acquisition module 310; the width-height ratio of the video displayed in the current video display window is contrasted with the width-height ratio of the target video display window by the width-height ratio contrast module 320; the width-height ratio of the target video display window is adjusted to the width-height ratio of the video by the first width-height ratio adjustment module 330 when the width-height ratio of the video is inconsistent with the width-height ratio of the target video display window, so that the video displayed after the current video display window is switched to the target video window would not be distorted due to deformation, thereby ensuring that the user can feel a good visual effect when watching the video.

Alternatively, the device for switching the video display windows in the present embodiment may further include:

a second width-height ratio adjustment module 340, which is configured to adjust a width-height ratio of an outer frame to the width-height ratio of the target video display window when the width-height ratio of the outer frame of the target video display window is inconsistent with the width-height ratio of the target video display window after the width-height ratio of the target video display window is adjusted to the width-height ratio of the video due to inconsistency between the width-height ratio of the video and the width-height ratio of the target video display window.

Alternatively, the first width-height ratio adjustment module 330 in the present embodiment is further configured for:

adjusting the width and/or the length of the target video display window so as to adjust the width-height ratio of the target video display window to the width-height ratio of the video.

Alternatively, the width-height ratio acquisition module 310 is further configured for:

acquiring the width-height ratio of the video by decoding the video displayed in the current video display window.

Alternatively, in all of the above embodiments, the current video display window may be a full screen display window, and the target video display window may be a preview window in non-full screen display.

The above device for switching the video display window can execute the method for switching the video display window provided in any embodiment of the present application, and has corresponding function modules for executing the method for switching the video display window.

Embodiments of the present application provide a non-transitory computer-readable storage medium for storing a computer executable instruction, which can execute the method for switching the video display window in any of the above-mentioned method embodiments.

FIG. 4 is a functional block diagram showing hardware for executing a method for switching video display window provided in embodiment 5 of the present application. As shown in FIG. 4, the device includes:

at least one processor 701 and a memory 702, where one processor 701 is taken as an example in FIG. 4.

The device may further include: an input device 703 and an output device 704.

The processor 701, the memory 702, the input device 703 and the output device 704 in the device may be connected by a bus or in other manners, and a connection by the bus is taken as an example in FIG. 4.

The memory 702 is used as a non-transitory computer readable storage medium; a program executable by the at least one processor 701 is stored in the memory 702; and the processor 701 is configured to execute the program stored in the memory 702 so as to execute the method for switching the video display window in any of the above-mentioned method embodiments. The memory 702 may include a program storage area and a data storage area, where the program storage area can store an operating system and application programs required by at least one function; and the data storage area may store data and the like created according to use of a terminal device. In addition, the memory 702 may include a high-speed random access memory, and may further include a non-transitory memory such as at least one magnetic disk memory device, a flash memory device or other non-transitory solid-state memory devices. In some embodiments, the memory 702 may selectively include memories remotely arranged relative to the processor 701, where these remote memories may be connected to the terminal device by a network. An example of the above-mentioned network includes but is not limited to an Internet, an Intranet, a local area network, a mobile communication network and a combination thereof.

The input device 703 may be configured to receive input digit or character information, and produce key signal input related to user setting and function control of the terminal. The output device 704 may include a display device such as a display screen.

The above-mentioned product can execute the method provided in embodiments of the present application, and has a corresponding function module for executing the method and beneficial effects. See the method provided in embodiments of the present application for technical details not described in this embodiment in detail.

The electronic equipment in embodiments of this application exists in various forms, including but not limited to:

(1) mobile telecommunication device. A device of this kind has a feature of mobile communicating function, and has a main object of providing voice and data communication. Devices of this kind include smart phone (such as iphone), multi-media cell phone, functional cell phone, low-end cell phone and the like;

(2) ultra mobile personal computer device. A device of this kind belongs to a category of personal computer, has functions of computing and processing, and generally has a feature of mobile internet access. Devices of this kind include PDA, MID, UMPC devices and the like, such as ipad;

(3) portable entertainment device. A device of this kind can display and play multi-media content. Devices of this kind include audio and video player (such as ipod), handheld game player, e-book, intelligent toy and portable vehicle navigation device;

(4) server, which is a device providing computing services. Construction of a server includes a processor, a hard disk, a memory, a system bus and the like. The server is similar to a common computer in architecture, but has high requirements in aspects of processing capacity, stability, reliability, security, expandability, manageability and the like since services of high reliability are needed to be provided;

(5) other electronic devices having data interacting functions.

Device embodiments described above are only illustrative, elements in the device embodiments illustrated as separated components may be or may not be physically separated, and components shown as elements may be or may not be physical elements, that is, the components may be located in one position, or may be distributed on a plurality of network units. Part or all of modules in the components may be selected according to actual requirements to achieve purpose of solutions in embodiments, which can be understood and perform by those of ordinary skill in the art without inventive works.

By descriptions of above embodiments, those skilled in the art can clearly learn that various embodiments can be achieved with aid of software and necessary common hardware platform, or with aid of hardware. Based on such an understanding, essential of above technical solutions or, in other words, parts of above technical solutions contributing to the related art may be embodied in form of software products which can be stored in a computer readable storage medium, such as a ROM/RAM, a disk, an optical disk and the like, and include a number of instructions configured to make a computer device (may be a personal computer, server, network device and the like) execute methods of various embodiments or parts of embodiments.

Finally, it should be noted that above embodiments are only used for illustrating but not to limit technical solutions of the present disclosure; although the present disclosure is described in detail with reference to the foregoing embodiments, those of ordinary skill in the art should understand that technical solutions recorded in the foregoing embodiments can be modified, or parts of the technical solutions can be equally replaced; and the modification and replacement dose not make essential of corresponding technical solutions depart from spirits and scope of technical solutions of various embodiments.

What is claimed is:

1. A method for switching video display window, comprising:
acquiring a width-height ratio of a video displayed in a current video display window and a width-height ratio of a target video display window when a video display window switching command is detected;
contrasting the width-height ratio of the video with the width-height ratio of the target video display window; and
adjusting the width-height ratio of the target video display window to the width-height ratio of the video when the width-height ratio of the video is inconsistent with the width-height ratio of the target video display window.

2. The method according to claim 1, after adjusting the width-height ratio of the target video display window to the width-height ratio of the video when the width-height ratio of the video is inconsistent with the width-height ratio of the target video display window, further comprising:
adjusting a width-height ratio of an outer frame to the width-height ratio of the target video display window when the width-height ratio of the outer frame of the target video display window is inconsistent with the width-height ratio of the target video display window.

3. The method according to claim 1, wherein the adjusting the width-height ratio of the target video display window to the width-height ratio of the current video display window comprises:
adjusting the width and/or the length of the target video display window so as to adjust the width-height ratio of the target video display window to the width-height ratio of the video.

4. The method according to claim 1, wherein the acquiring the width-height ratio of the video displayed in the current video display window comprises:
acquiring the width-height ratio of the video by decoding the video displayed in the current video display window.

5. The method according to claim 1, wherein the current video display window is a full screen display window, and wherein the target video display window is a preview window in non-full screen display.

6. An electronic device for switching video display window, comprising:
at least one processor; and
a memory communicably connected with the at least one processor for storing instructions executable by the at least one processor, wherein execution of the instructions by the at least one processor causes the at least one processor to:
acquire a width-height ratio of a video displayed in a current video display window and a width-height ratio of a target video display window when a video display window switching command is detected,
contrast the width-height ratio of the video with the width-height ratio of the target video display window, and
adjust the width-height ratio of the target video display window to the width-height ratio of the video when the width-height ratio of the video is inconsistent with the width-height ratio of the target video display window.

7. The electronic device according to claim 6, wherein the execution of the instructions by the at least one processor further causes the at least one processor to:
adjust a width-height ratio of an outer frame to the width-height ratio of the target video display window when the width-height ratio of the outer frame of the target video display window is inconsistent with the width-height ratio of the target video display window after the width-height ratio of the target video display window is adjusted to the width-height ratio of the video due to inconsistency between the width-height ratio of the video and the width-height ratio of the target video display window.

8. The electronic device according to claim 6, wherein the execution of the instructions by the at least one processor further causes the at least one processor to:
adjust the width and/or the length of the target video display window so as to adjust the width-height ratio of the target video display window to the width-height ratio of the video.

9. The electronic device according to claim 6, wherein the execution of the instructions by the at least one processor further causes the at least one processor to:
acquire the width-height ratio of the video by decoding the video displayed in the current video display window.

10. The electronic device according to claim 6, wherein the current video display window is a full screen display window, and wherein the target video display window is a preview window in non-full screen display.

11. The electronic device according to claim 7, wherein the current video display window is a full screen display window, and wherein the target video display window is a preview window in non-full screen display.

12. A non-transitory computer-readable storage medium storing executable instructions that, when executed by an electronic device, cause the electronic device to:
acquire a width-height ratio of a video displayed in a current video display window and a width-height ratio of a target video display window when a video display window switching command is detected;
contrast the width-height ratio of the video with the width-height ratio of the target video display window; and
adjust the width-height ratio of the target video display window to the width-height ratio of the video when the width-height ratio of the video is inconsistent with the width-height ratio of the target video display window.

13. The non-transitory computer-readable storage medium according to claim 12, after adjusting the width-height ratio of the target video display window to the width-height ratio of the video when the width-height ratio of the video is inconsistent with the width-height ratio of the target video display window, the executable instructions further cause the electronic device to:
adjust a width-height ratio of an outer frame to the width-height ratio of the target video display window when the width-height ratio of the outer frame of the target video display window is inconsistent with the width-height ratio of the target video display window.

14. The non-transitory computer-readable storage medium according to claim 12, wherein when adjusting the width-height ratio of the target video display window to the width-height ratio of the current video display window, the executable instructions cause the electronic device to:
adjust the width and/or the length of the target video display window so as to adjust the width-height ratio of the target video display window to the width-height ratio of the video.

15. The non-transitory computer-readable storage medium according to claim 12, wherein when acquiring the width-height ratio of the video displayed in the current video display window, the executable instructions cause the electronic device to:
acquire the width-height ratio of the video by decoding the video displayed in the current video display window.

16. The non-transitory computer-readable storage medium according to claim 12, wherein the current video display window is a full screen display window, and wherein the target video display window is a preview window in non-full screen display.
